(19) United States
(12) Patent Application Publication
(10) Pub. No.: US 2009/0064282 A1
(43) Pub. Date: Mar. 5, 2009

(54) METHOD FOR ORGANIZING ACTIVITIES IN ACTIVITY-CENTRIC COMPUTING NETWORKS

(75) Inventor: FuYi Li, Sudbury, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,020

(22) Filed: Aug. 29, 2007

(51) Int. Cl. G06F 21/22; G06F 3/048

(52) U.S. Cl. 726/4; 715/764

(57) ABSTRACT

A method for organizing activities in an activity-centric computing network includes receiving access to activities associated with at least one user of the activity-centric computing network, granting access to public tag information associated with at least a portion of the activities, granting access to private tag information associated with at least a portion of the activities, and organizing activities based on at least the public tag information and the private tag information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to activity-centric computing. Specifically, this invention relates to organizing activities in activity-centric computing networks.

2. Description of the Background

Activity-centric computing is a relatively new paradigm modeled on the way people work or perform work-related tasks. Workers, whether individually or in groups, engage in activities (e.g., projects, initiatives, etc.) defined by specific goals. An activity may be thought of as a unit of work encompassing the collection of relationships that emerge between people, the materials they work on, their communications and the processes they use to achieve their joint goal. Examples of activities include driving a sales process to close, preparing for a meeting, and managing a product rollout.

Activity-centric computing networks are networks which have the ability to employ activity-centric collaboration. Examples include local area networks, wide-area networks, the Internet, and other suitable networks. Terminals, or computer apparatuses, on the network may navigate to a specific web-page or initiate a user interface to see a list of all activities a user is involved in. Conventionally, user interfaces for activity-centric collaboration sort activities by the most recent changed order. However, people with many activities that are very dynamic may not need updates involving all of the activities most recently changed. Furthermore, with “sort by most recent changed” order, it is difficult to find a particular activity in a list of many activities.

Thus, in activity-centric collaboration, a user can have many activities. Some users may have more than hundreds of activities. Organizing these activities, especially providing a means to allow each individual user to organize them in a meaningful way to themselves, is a challenge.

### SUMMARY

A method for organizing activities in an activity-centric computing network includes receiving access to activities associated with at least one user of the activity-centric computing network, granting access to public tag information associated with at least a portion of the activities, granting access to private tag information associated with at least a portion of the activities, and organizing activities based on at least the public tag information and the private tag information. According to the method, the activities associated with the at least one user include all activities in the activity-centric computing network that are accessible to the at least one user, the public tag information includes at least one public tag directly associated with at least one activity, the at least one public tag is accessible to all users associated with the at least one activity, and the at least one public tag is modifiable by all users associated with the at least one activity. Furthermore, the private tag information includes at least one private tag directly associated with at least one activity, the at least one private tag is accessible only by the at least one user, and the at least one private tag is modifiable only by the at least one user and a system administrator.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system with an activity-centric computing network, according to an exemplary embodiment; and

FIG. 2 depicts a method for organizing activities in an activity-centric computing network, according to an exemplary embodiment.

The detailed description explains an exemplary embodiment, together with advantages and features, by way of example with reference to the drawings.

### DETAILED DESCRIPTION

According to an exemplary embodiment, a solution has been achieved which significantly increases the flexibility of organizing activities in activity-centric computing network. This increase in flexibility results in the ability to more readily locate, manipulate, and/or update activities in the computing network.

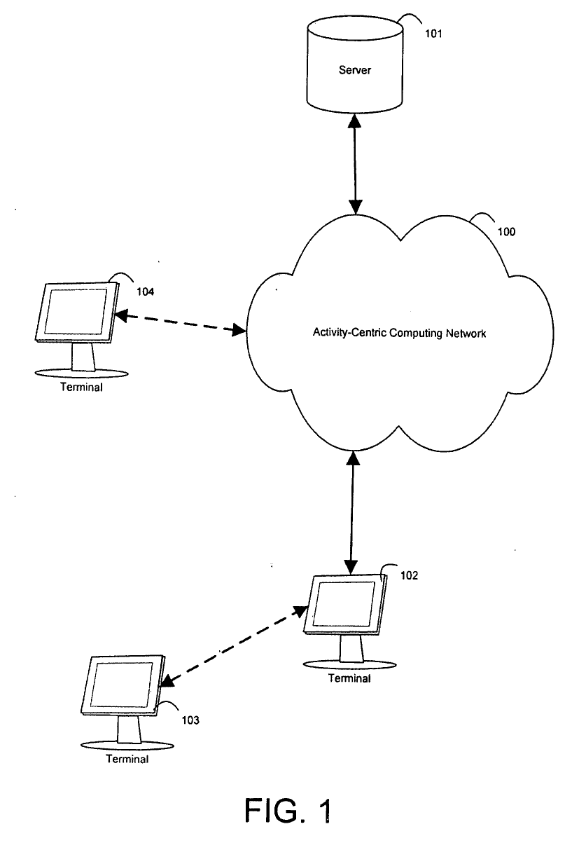

Turning to FIG. 1, a system according to an exemplary embodiment includes an activity-centric computing network 100. The activity-centric computing network 100 may include components necessary to implement activity-centric computing. For example, if a web-based application is used to allow users access to activities, a web-server may be an appropriate choice to store activities. If a program with a user interface is used to allow access to activities, a server or mainframe computer may be more suitable. Also, an activity-centric computing network may allow access to activities through a plurality of means. For example, a computing network may allow web-based activity access, server-based activity access, virtual private network access, telephony or modem access, and/or any suitable means. The activity-centric computing network may also include additional functionality (e.g., it may also be a local area network or other type of network). Therefore, an activity-centric computing network as described herein should apply to all implementations available now and in the future.

FIG. 1 further illustrates server 101 operatively connected to activity-centric computing network 100. Therefore, server 101 may be used for storage of activity-based information outside of activity-centric computing network 100. For example, server 101 may be a content server similar to a web-server, application server, or the like, and may enable activity-centric computing network 100 to access activities stored thereon. As such, terminals within activity centric-computing network 100 may gain access to activities and content on server 101. This is in addition to activities stored or organized within activity-centric computing network 100.

FIG. 1 further illustrates terminals 102, 103, and 104 operatively connected to activity-centric computing network 100. Terminals 102, 103, and 104 may be computer apparatuses, or similar devices, which enable a user of a respective terminal to access activities and content from activity-centric computing network 100. Further, as server 101 is operatively connected to activity-centric computing network 100, terminals 102, 103 and 104 may access activities stored thereon, in addition to those of activity-centric computing network 100. It is noted that the present invention should not be limited by any specific number of terminals and servers, or any particular configuration of said servers and terminals, as FIG. 1 illustrates the ability for servers and terminals to exist beyond an activity centric-computing network, and allows for other devices to be connected thereto as well. Hereinafter, a more detailed description of activities will be given, and particular forms of organization are also explained.

According to an exemplary embodiment, activities should be interpreted as unit of work shared by any number of users with access to an activity-centric computing network. Activities may be accessed through a user-interface (UI). The user-interface may be a customized software program enabling communication from a terminal (e.g., computer, PDA, cell-phone, etc) to an activity server. The user interface may also be a web-page accessed though a web-surfing program, a program accessed through a web-page (e.g., program loaded when web-page is accessed), or other suitable interfaces. The user-interface may access all activities a user is associated with, including all activities within a work-group, an office division, or the like. The user interface may allow a user to create new activities, edit or modify existing activities, and delete existing or complete activities. The activities may be displayed all at once, or filtered based on a constraint specified by the user. The constraints may take many forms.

With regards to example constraints, activities may be filtered based on a “priority” attribute. Priority allows the user to set an activity priority such as “important,” “less important,” “most important,” or other suitable priorities including a numeric priority based on a scale. The user interface may sort the activities by priority. For example, the user interface may sort in ascending priority order or descending priority order.

Another example constraint may be implemented with tags. A tag is a keyword or term associated with, or assigned to, an activity. Tags enable keyword-based searches on activities, sorting of activities using keywords or terms, and other similar organization. Therefore, tags may allow additional term or keyword based constraints to be used in filtering activities. For example, a user may filter to find all activities tagged with a specific word, or activities whose tags include a particular string of characters. According to the present invention, activities include the ability to be tagged by both public tags and private tags.

Public tags are tags that may be defined by any user who has access to an activity. Public tags may be viewed by any user having access to the activity (or a plurality of activities) associated with the public tags. For example, a user interface may display all activities a first user has access to. These activities may also be accessible to a second user. If the second user creates public tags for a subset of the activities, the first user may view these tags, sort the activities by these tags, and also choose to implement additional public tags to any activity the first user has access to. Similarly, the second user may also view the public tags created by the first user, sort the activities by these tags, and also choose to implement additional public tags. Thus, all users having access to a publicly tagged activity may view the public tags associated with the activity. However, exemplary embodiments are not limited to only public tags. Private tags may also be implemented.

Private tags are tags which are privately created by a user for activities said user has access to. A private tag may only be viewed by a user who created it. A more detailed description of aspects of private tags is given below.

Private tags may be personalized by a user. The user can use any terminology that makes sense to the user. For example, a user may use his/her name to privately tag activities. The user may also privately tag based on priority, social network, team of co-workers, co-workers' names, etc. Thus, the user may use any particular terminology the user wishes to describe activities. This is useful in that it allows personal descriptions which may make it easier for a user to sort their activities or workload.

Private tags may exist on activities which are also publicly tagged. However, private tags are only accessible to the user who created them. However, private tags may also be accessible/modifiable by a system administrator, according to an exemplary embodiment. Therefore, a user's activities may be sorted based on both public and private tags, only public tags, only private tags, priorities, activity descriptions, or any other constraints. Therefore, by using both public and private tags in addition to regular constraints, a user interface may better organize activities based on a user's needs. Workflow, efficiency, and other job-related parameters may be significantly increased in that a user is more able to view particular activities which may otherwise be surrounded by many other irrelevant activities.

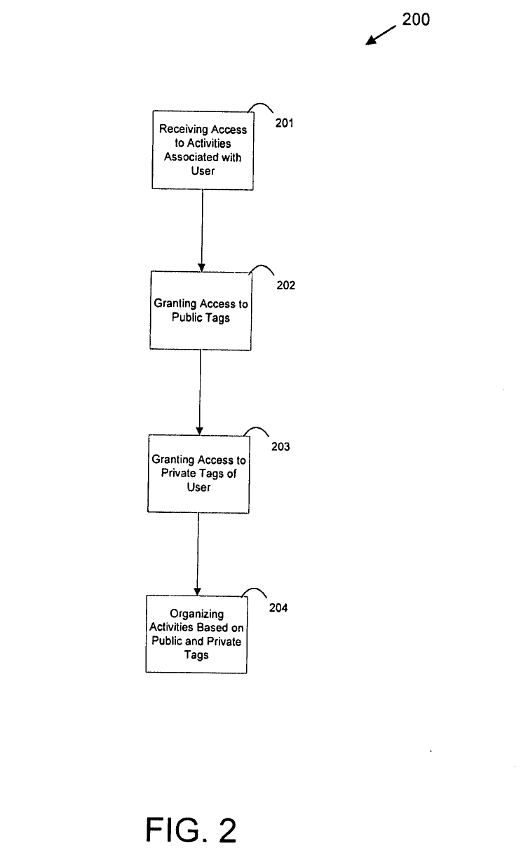

Private tags may be implemented and handled similar to public tags. A flag may be used to separate the two types of tags. A tag-cloud displaying all tags in a user interface may also display separate clouds (i.e., public cloud and private cloud). When creating a new tag, a user may specify whether the tag is public or private. Each activity may therefore list/group public tags and private tags existing for the activity (of course, private tags are only visible to the user who created the private tags. The user, who creates any private tags, may readily edit, delete, or perform any operation on the private tag. Additionally, a user who created a private tag may also convert the private tag to a public tag, for all users with access to the activity to readily view the new publicized tag. Hereinafter, a method according to an exemplary embodiment is described with reference to FIG. 2.

Turning to FIG. 2, a method for organizing activities in an activity-centric computing network is illustrated. The method 200 uses both public and private tags as described above, in combination with any other available constraint for sorting/filtering activities. The method may be performed by any terminal accessing or within the activity-centric computing network.

The method 200 includes, at block 201, receiving access to activities associated with a user. The user, employing a user interface as described above, may initiate a sequence to view his/her activities. Such initiation may include logging into an activity server, accessing an activity-centric computing network, starting up the user interface with his/her user information, and/or other similar operations. The user, now having access to all the activities available to him/her, may sort or organize activities using public/private tags and any suitable constraints.

The method 200 further includes granting access to public tags (see block 202). Granting access to public tags may include listing all public tags available, graphically representing the available public tags in a public tag-cloud, and/or displaying a flag for, or highlighting, each activity having a public tag. The user may then manipulate the activity listing to suit his/her needs based on the public tags. For example, a user may run a search for all public tags relating to a specific product or project. Also, the user may filter out any activities without public tags, or filter based on constraints including the public tag information.

The method 200 further includes granting access to private tags (see block 203). Granting access to private tags may include listing all private tags available, graphically representing the available private tags in a private tag-cloud, and/or displaying a flag for, or highlighting, each activity having a private tag. The user may then manipulate the activity listing to suit his/her needs based on the private tags. For example, a user may run a search for all private tags relating to a specific product or project. Also, the user may filter out any activities without private tags. It is noted that this may be used in combination with public tag access as described above. For example, a user may filter based on public and private tags, or based on a combination of constraints including public/private tag information.

The method 200 further includes organizing activities based on public and private tags (see block 204). For example, the user interface may organize all activities available to a user based on tags. A tag-cloud may be displayed including only particular types of tags (i.e., public or private). Alternatively, a listing of all public tags, a listing of all private tags, and/or a listing of all activities without tags may be displayed on the interface. Further, each tag-cloud or listing may be organized based upon last modification, priority, percent completion, and/or any suitable constraint. In this manner, the user interface better organizes activities to better suit a user's needs. Furthermore, the user interface provides a more meaningful display of activities which may better prepare the user to interact with activities or update co-workers on a project's completion.

Thus, as described above, an exemplary embodiment of the present invention provides a method for organizing activities in activity-centric computing networks. The present invention allows the same resource (e.g., activity) to be tagged with both public tags and private tags. If a resource is tagged with public tags only, the resource will not be included in a private tag-cloud or listing. If a resource is tagged with private tags only, the resource will not be included in a public tag-cloud or listing. If the resource is tagged with both public and private tags, the resource will be included in both public and associated users' private tag-cloud(s) or listings.

Thus as described above, activities including private tags are still available to users able to access the activity. Further, activities may include both public and private tags for a plurality of users.

Furthermore, as described above, an exemplary embodiment of the present invention improves the usability of tag-clouds and tag listings. For example, public tag listings may get to incredible sizes if there are many activities publicly tagged. However, because of the ability to also tag privately, a more detailed tag-cloud or listing may be provided to users. The detailed tag-cloud or listing includes all activities privately tagged by a user. Further, the user may filter or sort the tag-clouds or listings based on both public and private tags.

It is noted that an exemplary embodiment of the present invention may be performed by a suitable computer apparatus. The apparatus may be a terminal either within an activity-centric computing network, or a terminal operatively connected to an activity-centric computing network. The terminal may include, but should not be limited to, a computer terminal, laptop, PDA, cell-phone, and any other suitable apparatus. The terminal may include software or a web-browser to access activities available to a user.

Portions or the entirety of the method may be executed as instructions in a processor of the computer apparatus. Thus, the present invention may be implemented, in software, for example, as any suitable computer program. For example, a program in accordance with the present invention may be a computer program product causing a computer to execute the example method described herein: a method for organizing activities in activity-centric computing networks.

The computer program product may include a computer-readable medium having computer program logic or code portions embodied thereon for enabling a processor of a computer apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method for organizing activities in activity centric-computing networks, in accordance with an exemplary embodiment of the present invention.

While an exemplary embodiment has been described, it will be understood that those skilled in the art, both now and in the future, may make various improvements and enhancements which fall within the scope of the claims which follow. These claims should be construed to maintain the proper protection for the invention first described.

What is claimed is:

1. A method for organizing activities in an activity-centric computing network, comprising:
receiving access to activities associated with at least one user of the activity-centric computing network, wherein the activities associated with the at least one user include all activities in the activity-centric computing network that are accessible to the at least one user;
granting access to public tag information associated with at least a portion of the activities, wherein,
the public tag information includes at least one public tag directly associated with at least one activity,
the at least one public tag is accessible to all users associated with the at least one activity, and
the at least one public tag is modifiable by all users associated with the at least one activity;
granting access to private tag information associated with at least a portion of the activities, wherein,
the private tag information includes at least one private tag directly associated with at least one activity,
the at least one private tag is accessible only by the at least one user, and
the at least one private tag is modifiable only by the at least one user; and
organizing activities based on at least the public tag information and the private tag information.

2. The method of claim 1, wherein organizing activities includes:
organizing, at a user interface of a computer terminal, all activities associated with at least one user of the activity-centric computing network; and
graphically representing the activities on the user interface based on user-input constraints at the computer terminal.

3. The method of claim 2, wherein graphically representing includes at least one of:
displaying a public tag-cloud including all activities with public tags associated therewith;
displaying a private tag-cloud including all activities with private tags associated therewith;
displaying a public activity listing including all activities with public tags associated therewith;
displaying a private activity listing including all activities with private tags associated therewith; and
displaying a general activity listing including all activities with neither public tags or private tags associated therewith.

4. The method of claim 1, wherein:
the at least one private tag is also modifiable by a system administrator; and
the at least one private tag is also accessible by a system administrator.

5. The method of claim 1, wherein the at least one private tag is made accessible to all users through modification into a public tag by the at least one user.

6. A computer-readable medium including computer instructions that, when executed on a host processor of a computer apparatus, directs the host processor to perform a method for organizing activities in an activity-centric computing network available to the computer apparatus, the method comprising:
receiving access to activities associated with at least one user of the activity-centric computing network, wherein the activities associated with the at least one user include all activities in the activity-centric computing network that are accessible to the at least one user;
granting access to public tag information associated with at least a portion of the activities, wherein,
the public tag information includes at least one public tag directly associated with at least one activity,
the at least one public tag is accessible to all users associated with the at least one activity, and
the at least one public tag is modifiable by all users associated with the at least one activity;
granting access to private tag information associated with at least a portion of the activities, wherein,
the private tag information includes at least one private tag directly associated with at least one activity,
the at least one private tag is accessible only by the at least one user, and
the at least one private tag is modifiable only by the at least one user; and
organizing activities within a user-interface on the computer apparatus based on at least the public tag information and the private tag information.
